(19) United States
(12) Patent Application Publication
(10) Pub. No.: US 2026/0187937 A1
(43) Pub. Date: Jul. 2, 2026

(54) GENERATING THREE-DIMENSIONAL OBJECT BASED ON ENVIRONMENT

(71) Applicant: GOOGLE LLC, Mountain View, CA (US)

(72) Inventors: Yasmine Quintana Evjen, Alameda, CA (US); Cory Michael Cook, San Jose, CA (US); Joshua Thomas Buffum, Rocklin, CA (US); Patrick Michael Fuentes, Mountain View, CA (US)

(21) Appl. No.: 19/427,528

(22) Filed: Dec. 19, 2025

Related U.S. Application Data
(60) Provisional application No. 63/739,229, filed on Dec. 27, 2024.

(51) Int. Cl. G06T 19/00; G06F 3/04815; G06F 3/04845

(52) U.S. Cl. CPC G06T 19/00; G06F 3/04815; G06F 3/04845; G06T 2200/24

(57) ABSTRACT

A method includes determining, at a first computing device and in response to a request to generate an object, that an environment in which an application is executing has three dimensions; generating a three-dimensional object based on at least one parameter included in the request and based on determining that the environment has three dimensions; in response to receiving input associated with the object, generating a modification of a state of the three-dimensional object; and sending the modification of the state of the three-dimensional object to a second computing device, the second computing device executing the application in an environment having two dimensions.

### CROSS-REFERENCE TO RELATED APPLICATION

This application claims priority to U.S. Provisional Application No. 63/739,229, filed December 27, 2024, the disclosure of which is hereby incorporated by reference.

### BACKGROUND

Developers draft code to generate objects within applications. Some applications have two-dimensional environments, whereas some applications have three-dimensional environments.

### SUMMARY

An object can be generated as either a two-dimensional object or a three-dimensional object depending on whether an environment in which the object will be included is a two-dimensional environment or a three-dimensional environment. The object can be generated as part of a function, which can be implemented as an application programming interface (API). The function can determine whether the environment is a two-dimensional environment or a three-dimensional environment. If the environment is a two-dimensional environment, then the function can generate the object as a two-dimensional object. If the environment is a three-dimensional environment, then the function can generate the object as a three-dimensional object.

According to an example, a method includes determining, at a first computing device and in response to a request to generate an object, that an environment in which an application is executing has three dimensions; generating a three-dimensional object based on at least one parameter included in the request and based on determining that the environment has three dimensions; in response to receiving input associated with the object, generating a modification of a state of the three-dimensional object; and sending the modification of the state of the three-dimensional object to a second computing device, the second computing device executing the application in an environment having two dimensions.

According to an example, a non-transitory computer-readable storage medium includes instructions stored thereon. When executed by at least one processor, the instructions are configured to cause a first computing device to determine, in response to a request to generate an object, that an environment in which an application is executing has three dimensions; generate a three-dimensional object based on at least one parameter included in the request and based on determining that the environment has three dimensions; in response to receiving input associated with the object, generating a modification of a state of the three-dimensional object; and sending the modification of the state of the three-dimensional object to a second computing device, the second computing device executing the application in an environment having two dimensions.

According to an example, a first computing device includes at least one processor and a non-transitory computer-readable storage medium comprising instructions stored thereon. When executed by at the least one processor, the instructions are configured to cause the first computing device to determine that an environment in which an application is executing has three dimensions in response to receiving a request to generate an object; generate a three-dimensional object based on at least one parameter included in the request and based on determining that the environment has three dimensions; in response to receiving input associated with the object, generating a modification of a state of the three-dimensional object; and sending the modification of the state of the three-dimensional object to a second computing device, the second computing device executing the application in an environment having two dimensions.

The details of one or more implementations are set forth in the accompanying drawings and the description below. Other features will be apparent from the description and drawings, and from the claims.

### BRIEF DESCRIPTION OF THE DRAWINGS

FIG. 1A shows a first user viewing a three-dimensional scene and a second user viewing a two-dimensional display.

FIG. 1B shows a first user viewing a three-dimensional scene and a second user viewing a two-dimensional display.

FIG. 2 shows pseudocode for generating a two-dimensional or three-dimensional object.

FIGS. 3A and 3B show planes extending through a three-dimensional object for generating a two-dimensional object based on the three-dimensional object.

FIG. 4A shows subspaces for generating a three-dimensional object based on a two-dimensional object extending along a plane.

FIG. 4B shows options for extension of a two-dimensional object in a third dimension to generate a three-dimensional object based on the two-dimensional object.

FIG. 5 shows a two-dimensional parent panel and two-dimensional child panels.

FIGS. 6A through 6F show a three-dimensional parent panel and three-dimensional child panels generated based on the two-dimensional parent panel and two-dimensional child panels of FIG. 5.

FIG. 7 shows a flowchart for generating a two-dimensional object or three-dimensional object.

FIG. 8 is a block diagram of a computing system.

FIGS. 9A, 9B, and 9C show an implementation of a head-worn device.

FIG. 9D shows another implementation of the head-worn device.

FIG. 10 is a flowchart of a method.

Like reference numbers refer to like elements.

### DETAILED DESCRIPTION

Applications can execute in two-dimensional environments, displayed on a traditional flat display, as well as in three-dimensional environments, such as virtual reality (VR) or eXtended Reality (XR) environments. A technical problem with applications that execute in both two-dimensional environments and three-dimensional environments is that objects generated by the applications have either two dimensions or three dimensions and have difficulty interacting with other objects with different levels of dimensionality. Separately writing code for two-dimensional environments and three-dimensional environments can be tedious and introduce the possibility of mistakes that can cause problems during execution of the application.

A technical solution to this technical problem is to implement a function that generates an object with either two dimensions or three dimensions depending on whether the environment is two-dimensional or three-dimensional. The function can be implemented as an application programming interface (API) included in computer-executable code that launches the application on a computing device. The function can determine whether the environment in which the application is executing is a two-dimensional environment or a three-dimensional environment, and generate a two-dimensional object or three-dimensional object to match the dimensionality of the environment. This technical solution has the technical benefit of enabling developers to write one set of code for an application that applies in both two-dimensional environments and three-dimensional environments, saving time and reducing the likelihood of mistakes from applications on different computing devices not interacting with each other properly. The environment can include a runtime context for an application that defines the coordinate system for rendering visual objects. For example, a two-dimensional environment may utilize a two-dimensional coordinate system for presentation on a flat display, and a three-dimensional environment may utilize a three-dimensional coordinate system for presentation in a virtual or extended reality scene.

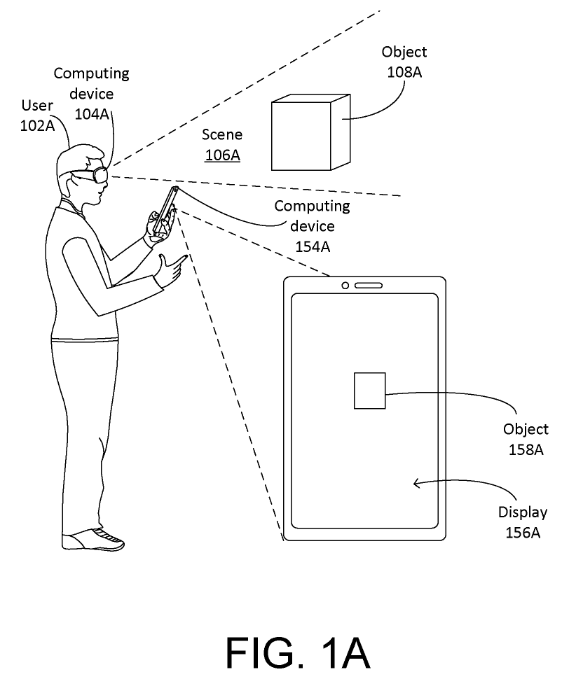

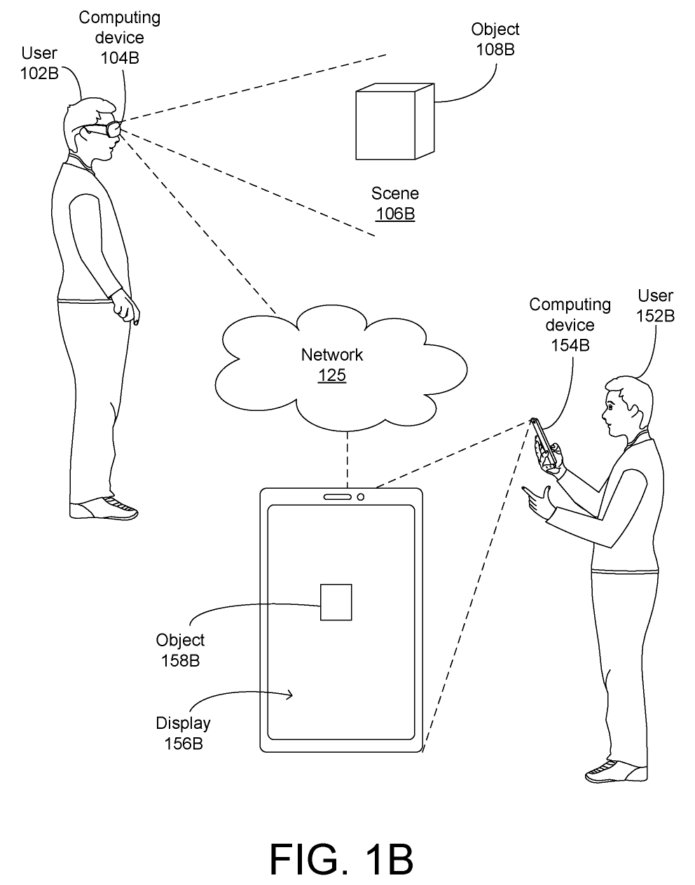

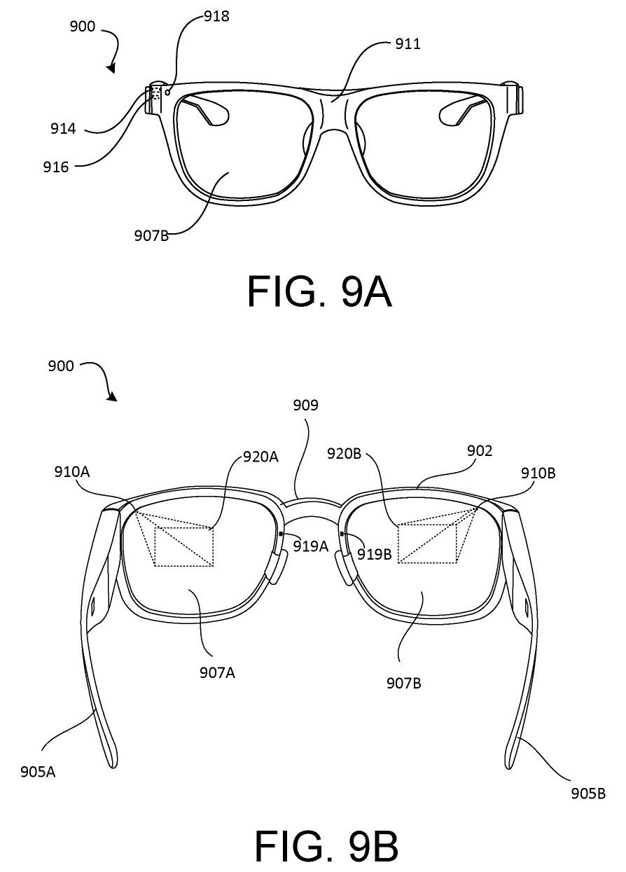

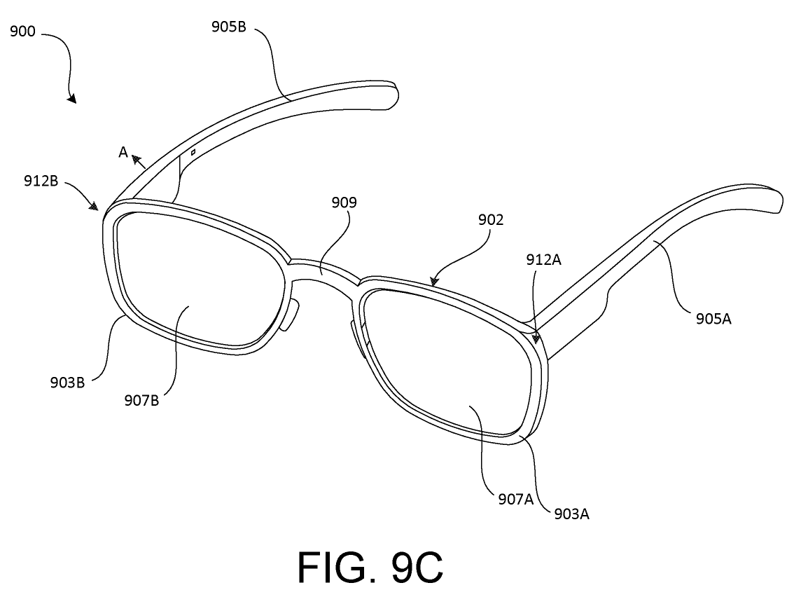

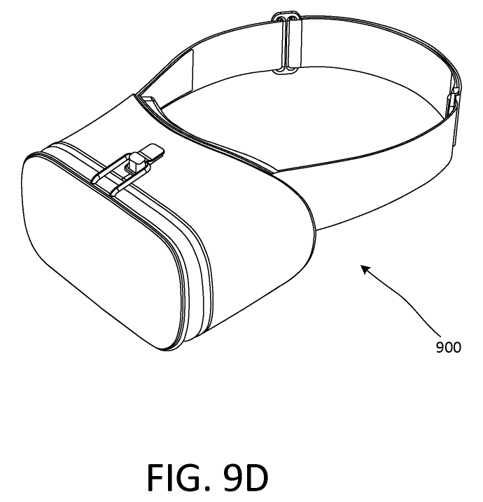

FIG. 1A shows a user 102A viewing a three-dimensional scene 106A and a two-dimensional display 156A. The user 102A is viewing the three-dimensional scene 106A via a first computing device 104A. FIGS. 9A through 9D show examples of the first computing device 104A. The user 102A is also viewing the two-dimensional display 156A via a second computing device 154A. The second computing device can be a computing device that includes a two-dimensional display such as the two-dimensional display 156A, such as a smartphone, a tablet, a phablet, a laptop or notebook computer, a netbook, or a desktop or tower computer, as non-limiting examples. The three-dimensional scene 106A can be part of a virtual reality (VR) or eXtended reality (XR) environment generated by the first computing device 104A. The first computing device 104A can generate the three-dimensional scene based on instructions from the second computing device 154A.

The first computing device 104A can be executing a second instance of a same application as the second computing device 154A. The application executing on the first computing device 104A and the second computing device 154A can be a gaming application or other application in which the user 102A interacts with objects that are shared between the first computing device 104A and the second computing device 154A. An application can include a software program configured to create a logical space, having either two or three dimensions, wherein objects are generated and their states are managed in response to user input or programmatic events. A three-dimensional object 108A displayed in the three-dimensional scene 106A presented by the first computing device 104A can correspond to a two-dimensional object 158A presented by the two-dimensional display 156A of the second computing device 154A. Input from the user 102A into the first computing device 104A that affects the three-dimensional object 108A (i.e. that is associated with the three-dimensional object 108A) can affect the two-dimensional object 158A. Input from the user 102A into the second computing device 154A that affects the two-dimensional object 158A (i.e. is associated with the two-dimensional object 158A) can affect the three-dimensional object 108A. The three-dimensional object 108A and two-dimensional object 158A can be representations of an object in a shared environment with which the user 102A can interact via either the first computing device 104A or the second computing device 154A. In absence of dimensionality, an object can include a data construct within an application, having properties that define an appearance and state of the object, and capable of being rendered with a dimensionality corresponding to the application's environment. With reference to dimensionality (such as a two-dimensional object or three-dimensional object), an object can include a distinct visual element rendered by an application, with which a user can interact and whose visual representation is generated as either a two-dimensional or a three-dimensional entity based on the runtime environment.

Objects within a shared environment, such as an object represented by the three-dimensional object 108A, two-dimensional object 158A, can interact across different display dimensions through a system that separates a visual representation of the object from underlying data, or a “state” associated with the object. The separation of the visual representation from the state allows a user on a two-dimensional (2D) display, such as the user 102A, and a user in a three-dimensional (3D) virtual reality environment, such as the user 102A, to interact in different environments with the same object, even though the appearance of the object in the respective two-dimensional and three-dimensional environments is tailored to the respective two-dimensional and three-dimensional views. The interaction can be facilitated by features such as environment detection, conditional rendering, and state synchronization. The three-dimensional object 108A and two-dimensional object 158A can be considered different visual representations of a single, abstract object. The object can be defined by a set of data shared between the first computing device 104A and second computing device 154A. The set of data can be considered a state of the object. The state can include properties such as shape, size, position, rotation, and/or color. When a user 102A interacts with the object, rather than interacting with the visual representation of the three-dimensional object 108A or two-dimensional object 158A presented by the three-dimensional scene 106A or two-dimensional display 156A, the user 102A is sending input to the computing devices 104A, 154A that modifies the shared state of the object.

The detection of the environment in which the applications that generate representations of the object are executing enables generation of a two-dimensional object or three-dimensional object based on whether the environment in which the application is executing is two-dimensional or three-dimensional. Computer-executable code for generating the three-dimensional object 108A within the three-dimensional scene 106A can also generate the two-dimensional object 158A within the two-dimensional display 156A. The computer-executable code can implement a function that receives parameters for an object, determines whether an environment in which the object will be generated and/or placed in a two-dimensional environment or three-dimensional environment, and generates either a two-dimensional object or three-dimensional object corresponding to the dimensionality of the environment based on the parameters. The function can be implemented as an application programming interface (API) that receives the parameters, determines whether the environment is two-dimensional or three-dimensional, and generates the object based on the received parameters and the dimensionality of the environment. A parameter can include an argument passed to a function call, the argument providing a value that specifies a characteristic or property for an object to be generated.

In the example shown in FIG. 1A, a parameter for the function call executing on the first computing device 104A indicates that the object should have a square or cubical shape. The function executing on the first computing device 104A determines that the environment is three-dimensional. Based on determining that the environment is three-dimensional and the parameter indicating that the object should have a square or cubical shape, the function executing on the first computing device 104A generates the cubical three-dimensional object 108A.

In the example shown in FIG. 1A, a parameter for the function call executing on the second computing device 154A indicates that the object should have a square or cubical shape. The function executing on the second computing device 154A determines that the environment is two-dimensional. Based on determining that the environment is two-dimensional and the parameter indicating that the object should have a square or cubical shape, the function executing on the second computing device 154A generates the square two-dimensional object 158A.

Interaction with the shared object represented as the three-dimensional object 108A on the first computing device 104A and two-dimensional object 158A on the second computing device 154A, as well as other objects, by the user, can be a continuous, bidirectional loop of communication that maintains the shared state synchronized between the first computing device 104A and the second computing device 154A. A user can perform an action, such as the user 102A clicking and dragging the two-dimensional object 158A across the two-dimensional display 156A, or the user 102A reaching out and pushing the three-dimensional object 108A within the three-dimensional scene 106A. The application on the computing device 104A, 154A on which the action was performed can capture the input and translate the input into a change of the state of the shared object (such as updating positional coordinates of the object). The computing device 104A, 154A on which the action was performed can send an indication of the change of state to the other computing device 104A, 154A. In some implementations, the computing device 104A, 154A on which the action was performed can send the indication of the change of state to the other computing device 104A, 154A within an action message. The other computing device 104A, 154A that receives the indication of the change of state can update state information of the object. Based on receiving the change of state, the computing device 104A, 154A that received the indication of the change of state can update a locally stored state of the object. The computing device 104A, 154A that received the indication of the change of state update can re-render the local presentation of the object to reflect the changed state, such as changing the presentation of the three-dimensional object 108A or two-dimensional object 158A. The movement presented by the receiving computing device 104A, 154A can correspond to the movement of the sending computing device 104A, 154A. This process ensures that actions performed in an environment of a particular dimensionality (two dimensions or three dimensions) are accurately reflected in the other environment with a different dimensionality, creating a consistent state for the objects 108A, 158A within the scene 106A and display 156A.

A subspace composable can act as a bridge that allows a three-dimensional layout system (a “subspace”) to be created and managed from within a two-dimensional application context. By enabling two-dimensional and three-dimensional applications to share state, context, and logic, the subspace composable allows for interactions where, for example, a two-dimensional user interface can directly influence the placement and behavior of a three-dimensional object, and vice versa. This approach minimizes development costs by eliminating the need to build and maintain two separate applications.

FIG. 1B shows a first user 102B viewing a three-dimensional scene 106B and a second user 152B viewing a two-dimensional display 156B. The first user 102B is viewing the three-dimensional scene 106B via a first computing device 104B. FIGS. 9A through 9D show examples of the first computing device 104B. The second user 152B is viewing the two-dimensional display 156B via a second computing device 154B. The second computing device can be a computing device that includes a two-dimensional display such as the two-dimensional display 156B, such as a smartphone, a tablet, a phablet, a laptop or notebook computer, a netbook, or a desktop or tower computer, as non-limiting examples. The three-dimensional scene 106B can be part of a virtual reality (VR) or eXtended reality (XR) environment generated by the first computing device 104B. The first computing device 104B and second computing device 154B can communicate with each other via a network 125 such as the Internet, a local area network (LAN), or a wireless local area network (WLAN), as non-limiting examples. The first user 102B, first computing device 104B, scene 106B, object 108B, second computing device 154B, second display 156B, and second object 158B can have similar features as the user 102A, first computing device 104A, scene 106A, object 108A, second computing device 154A, second display 156A, and second object 158B described above with respect to FIG. 1A. The maintenance of a shared state between the computing devices 104B, 154B ensures that actions performed in an environment of a particular dimensionality (two dimensions or three dimensions) are accurately reflected in the other environment with a different dimensionality, creating a seamless, interactive shared experience for the users 102B, 152B.

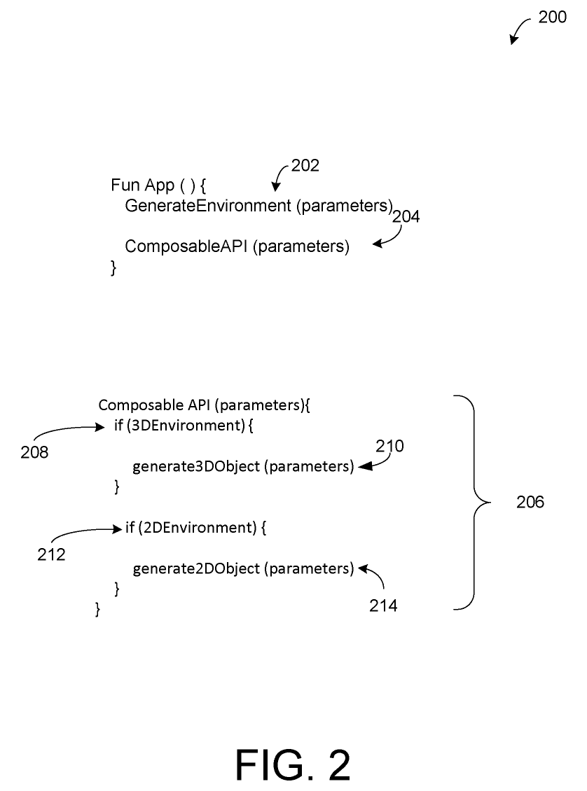

FIG. 2 shows pseudocode 200 for generating a two-dimensional or three-dimensional object. The pseudocode 200 represents, or can provide a guide for drafting, computer-executable code that will generate a two-dimensional object or three-dimensional object depending on whether the environment in which the object will be placed is two-dimensional or three-dimensional.

The pseudocode 200 can include code for launching an application, such as a gaming application. The pseudocode 200 can include an instruction 202 to generate an environment. The instruction 202 can include a function call that generates an environment. The environment generated in response to the instruction 202 can include a three-dimensional environment, such as the three-dimensional scene 106A, 106B, or a two-dimensional environment that will be presented on a two-dimensional display such as the two-dimensional display 156A, 156B.

The pseudocode 200 can include a function 204 that generates either the two-dimensional object or the three-dimensional object. The function 204 can receive parameters, such as the shape of the object to be created. The parameters received by the function 204 can include a shape of the object, a color of the object, how the object moves within the environment, and how the object interacts with other objects, as non-limiting examples. While FIG. 2 shows only one parameter received by the function 204 for illustrative purposes, the function 204 can also receive multiple parameters for generating the object. The function 204 can be an application programming interface (API) called by a developer to add a two-dimensional object or three-dimensional to an application depending on whether the environment of the application is two-dimensional or three-dimensional.

The pseudocode 200 includes an implementation 206 of the function 204. The implementation 206 can be a function definition written by a developer, or an API implementation called by the developer. The implementation 206 can be stored on the computing device on which the application is executing, or on a remote computing device in communication with the computing device on which the application is executing.

The implementation 206 can include determinations of whether the environment is two-dimensional or three-dimensional. In the example shown in FIG. 2, the implementation 206 includes a determination 208 of whether the environment is three-dimensional. If the environment is three-dimensional, then the implementation 206 includes a generation 210 of a three-dimensional object. The generation 210 of the three-dimensional object includes generating the three-dimensional object based on the received parameters. In the example shown in FIG. 2, the implementation 206 includes a determination 212 of whether the environment is two-dimensional. If the environment is two-dimensional, then the implementation includes a generation 214 of a two-dimensional object. The generation 214 of the two-dimensional object includes generating the two-dimensional object based on the received parameters.

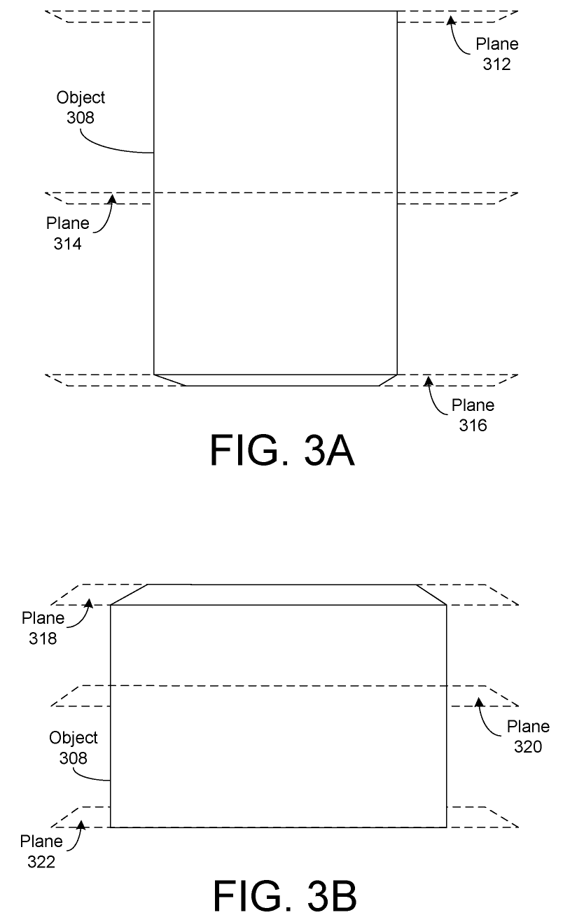

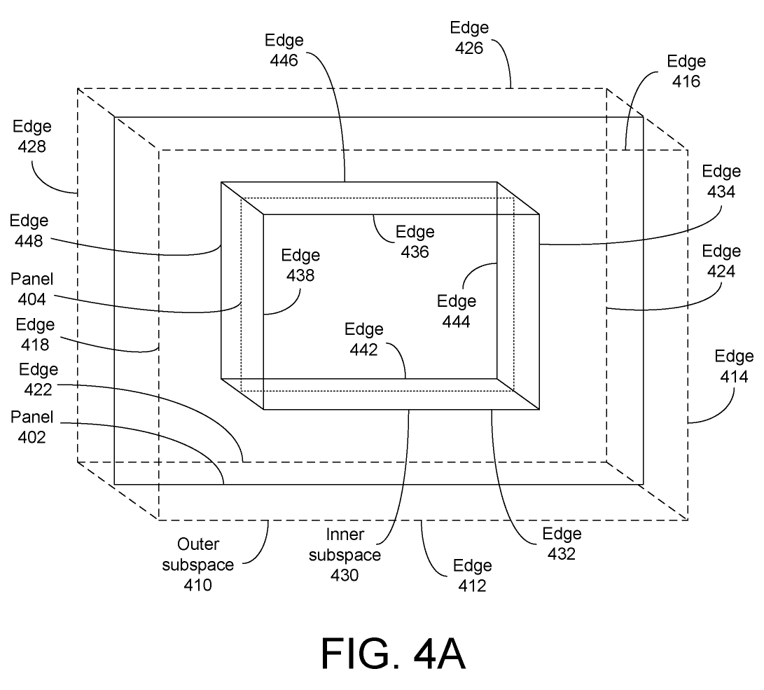

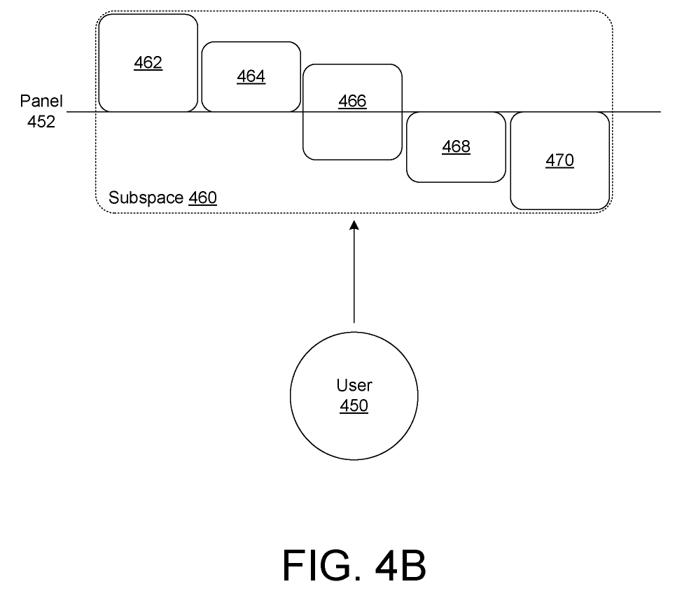

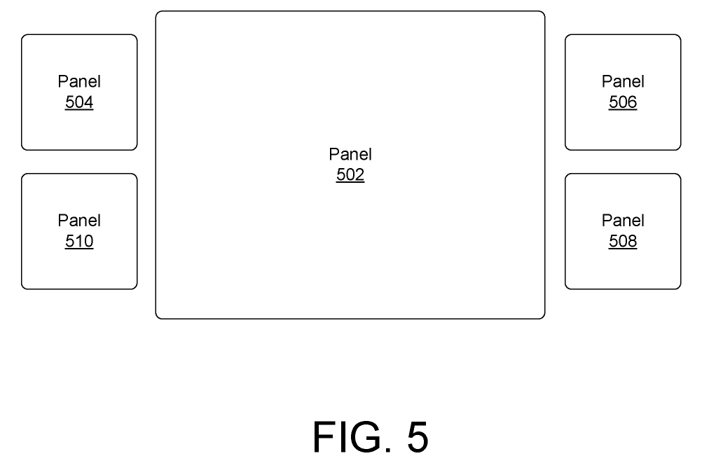

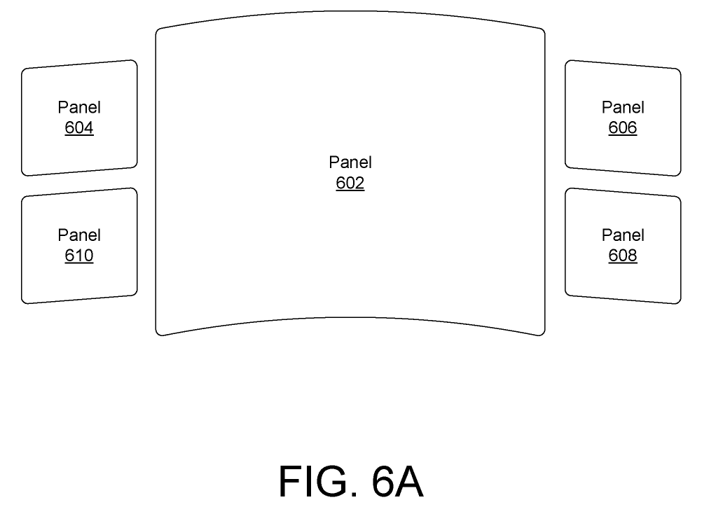

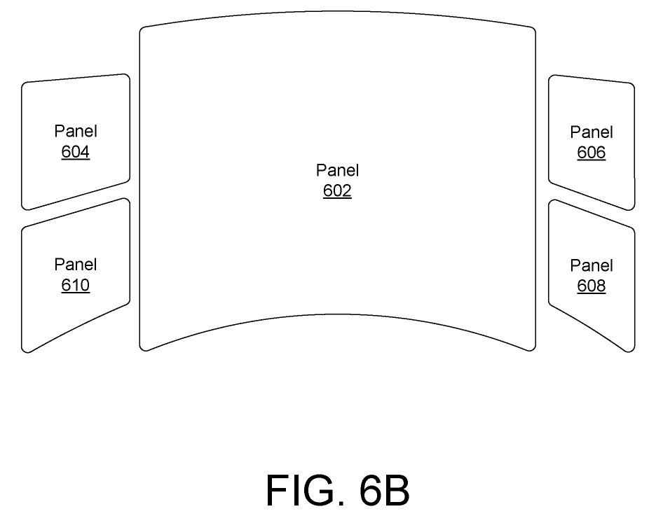

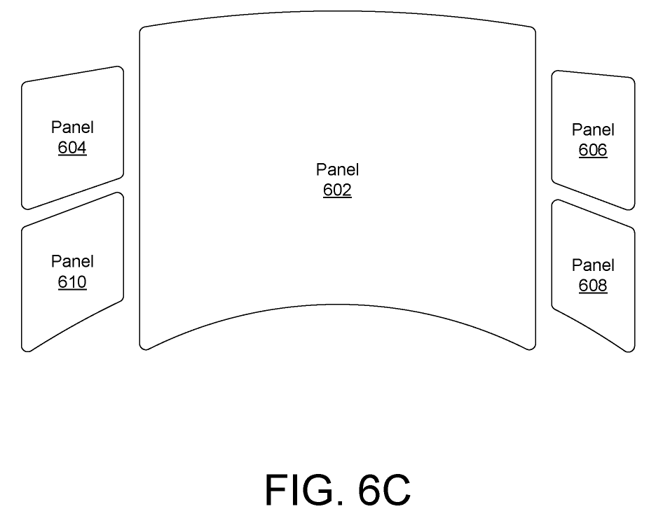

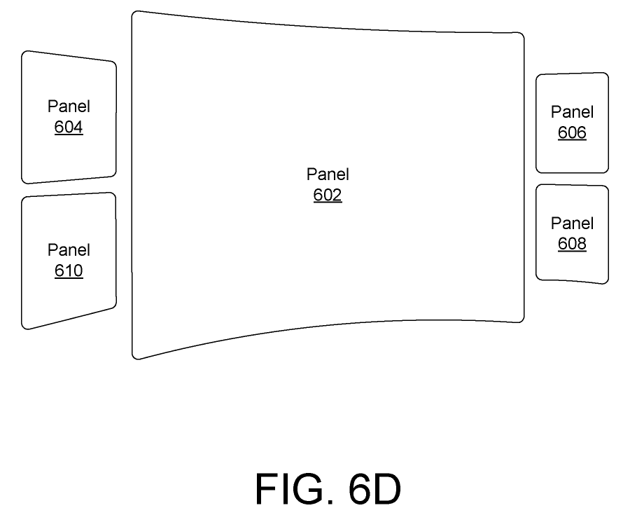

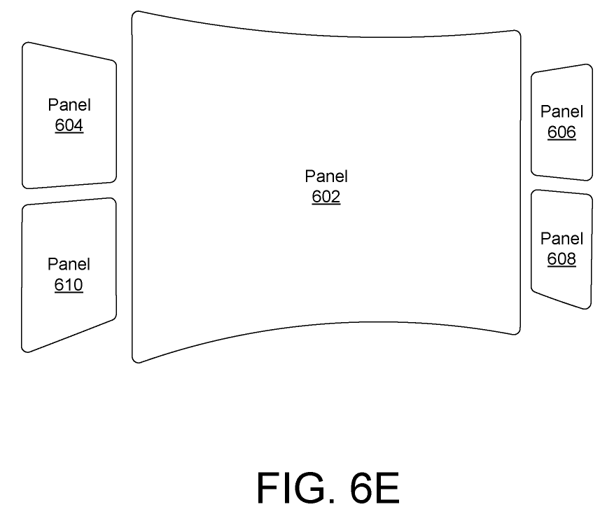

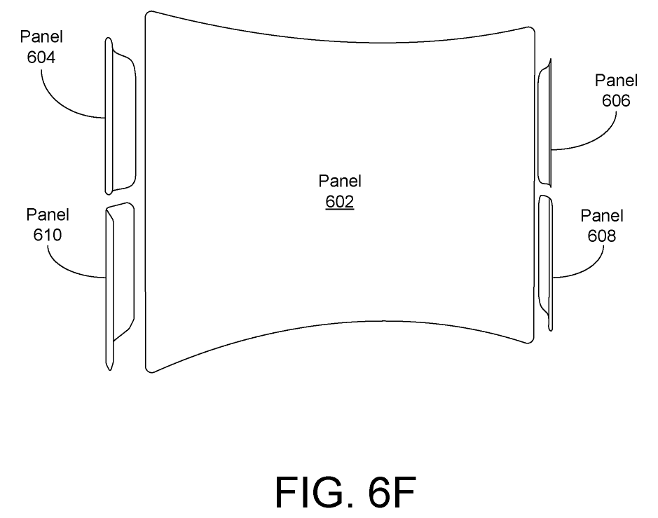

In some implementations, parameters for generating a two-dimensional object can be determined based on a three-dimensional object. In some implementations, parameters for generating a three-dimensional object can be determined based on a two-dimensional object. FIGS. 3A and 3B show generation of a two-dimensional object based on a three-dimensional object. FIGS. 4A and 4B show generation of a three-dimensional object based on a two-dimensional object. FIGS. 6A through 6F show three-dimensional panels that can be generated based on two-dimensional panels shown in FIG. 5.

FIGS. 3A and 3B show planes 312, 314, 316, 318, 320, 322 extending through a three-dimensional object 308 for generating a two-dimensional object based on the three-dimensional object 308. FIGS. 3A and 3B show the same three-dimensional object 308, with the three-dimensional object 308 rotated in FIG. 3B compared to the view shown in FIG. 3A for ease of showing different planes 312, 314, 316, 318, 320, 322. A function that generates a two-dimensional object can generate the two-dimensional object based on a plane, such as any of the planes 312, 314, 316, 318, 320, 322, extending through a three-dimensional object, such as the three-dimensional object 308. The two-dimensional object can include properties of the three-dimensional object along the plane, such as the shape and color of the three-dimensional object along the plane. In the example shown in FIGS. 3A and 3B, the two-dimensional object could be rectangular, with width and height based on the width and height of the portion of the rectangular prism or cuboid three-dimensional object 308 through which the plane 312, 314, 316, 318, 320, 322 extends. In some implementations, the two-dimensional object can have a color based on an exterior portion of the rectangular prism or cuboid three-dimensional object 308 through which the plane 312, 314, 316, 318, 320, 322 extends.

The function can extract features of the two-dimensional object based on a plane intersecting a three-dimensional object, such as any of the plane 312, 314, 316, 318, 320, 322 intersecting the three-dimensional object 308. The extraction of the features of the two-dimensional object from the three-dimensional object allows the application to represent a complex three-dimensional shape in a simplified two-dimensional view suitable for a flat-screen display such as the two-dimensional display 156A, 156B.

The function can first generate a three-dimensional object, such as the three-dimensional object 308, based on at least one parameter included in a request. The at least one parameter might define a shape (e.g., cubical), size, and any other properties. The function can define a two-dimensional plane to extend through the three-dimensional object. The position and orientation of this plane determine what cross-section of the three-dimensional object will be used to generate the two-dimensional object. The function can then generate the two-dimensional object by extracting the features of the three-dimensional object that lie along the defined plane. The resulting two-dimensional object can be considered a “slice” or cross-section of the original three-dimensional object. The newly generated two-dimensional object inherits properties from the cross-section of the three-dimensional object that the two-dimensional object was based on. The properties can include characteristics like the shape and color of the three-dimensional object along the defined plane. For example, a plane extending through a three-dimensional rectangular prism would generate a two-dimensional rectangle. In some implementations, the generation of the two-dimensional object includes a conditional logic flow in which the application first determines that the application is operating in a two-dimensional environment and then generates the appropriate two-dimensional representation from a canonical three-dimensional model.

FIG. 4A shows subspaces for generating a three-dimensional object based on a two-dimensional object extending along a plane. The two-dimensional object can extend along panels 402, 404. The panels 402, 404 shown in the example of FIG. 4A are two-dimensional objects such as rectangles. The application that generates the three-dimensional object can create the three-dimensional object based on the two-dimensional object by extending the three-dimensional object in a dimension or direction orthogonal or perpendicular to the dimensions of the two-dimensional object. In an implementation in which the two-dimensional object extends in an x-dimension and a y-dimension, the application can extend the three-dimensional object in a z-dimension from the two-dimensional object.

In the example shown in FIG. 4A, the application can generate a three-dimensional object from a two-dimensional object by creating an inner subspace by extending the rectangular panel 404 into a rectangular prism or cuboid with a top face defined by edges 432, 434, 436, 438, and a bottom face defined by edges 442, 444, 446, 448. The application can generate a three-dimensional object from a two-dimensional object by creating an outer subspace by extending the rectangular panel 402 into a rectangular prism or cuboid with a top face defined by edges 412, 414, 416, 418, 438, and a bottom face defined by edges 422, 424, 426, 428.

While the application generated the three-dimensional object by extending the three-dimensional object from the two-dimensional object in two directions (front and back or top and bottom) in the example of FIG. 4A, effectively placing the two-dimensional object in the middle of the three-dimensional object, this is merely an example. In other implementations, the application can generate the three-dimensional object by extending the three-dimensional object in a single direction, such as front or back, from the two-dimensional object.

The subspaces 430, 410 can act as a bridge to allow developers to create and manage a three-dimensional layout system from within a traditional two-dimensional application context. This bridge is useful for adapting existing two-dimensional applications for three-dimensional environments, such as extended reality (XR) environments, without having to build a separate three-dimensional application.

The developer can call a function, such as a “subspace composable” function, within existing two-dimensional user interface code. The function (e.g. subspace composable function) acts as an entry point to a new three-dimensional layout system. The function creates a subgraph of layout nodes capable of handling the third dimension (e.g. the z-axis). The function can extend a two-dimensional element, such a panel, into the three-dimensional subspace. For example, a flat two-dimensional panel can be the basis for a three-dimensional rectangular prism or cuboid. The function can extend the object in a direction orthogonal to the two-dimensional plane of the two-dimensional object from which the three-dimensional object is generated (e.g., forward, backward, or centered on the original plane). This approach allows the two-dimensional and three-dimensional environments to share state of objects, context, and logic. A change in the two-dimensional user interface can trigger a re-evaluation and update in the three-dimensional layout, and vice-versa, creating an interactive and cohesive experience.

FIG. 4B shows options for extension of a two-dimensional object in a third dimension to generate a three-dimensional object based on the two-dimensional object. The two-dimensional object can extend along a panel 452. The application can generate the three-dimensional object by extending the three-dimensional object from the panel 452 in a front direction toward a user 450 within a subspace 460, as shown in example three-dimensional objects 468, 470, in a back direction away from the user 450 as shown in example three-dimensional objects 462, 464 within the subspace 460, or in both the front and back directions within the subspace 460 so that the panel 452 extends through a center depth wise in the example three-dimensional object 466.

The function can treat the two-dimensional panel 452 as a flat plane within a three-dimensional space and extend the panel along a third axis to give the panel depth. The function can begin with a two-dimensional object, such as a panel defined by two (e.g. x and y) dimensions, and extend the panel along a third (e.g z) axis, which is orthogonal (i.e. perpendicular) to the original two-dimensional plane of the panel. This process extrudes the two-dimensional shape into a three-dimensional volume. For example, a rectangular two-dimensional panel can be extended to become a three-dimensional rectangular prism or cuboid. This extension of the panel into a three-dimensional object can occur within a “subspace,” which can be considered a three-dimensional layout system generated from within the two-dimensional context. The subspace composable creates a subgraph of layout nodes capable of handling the third (e.g. z) dimension. The developer can control how the extension occurs. In some implementations (such as three-dimensional objects 468, 470), the three-dimensional object can be generated by front alignment, in which the object is extended forward from the two-dimensional panel. In some implementations (such as three-dimensional objects 462, 464), the three-dimensional object can be generated by back alignment, in which the object is extended backward from the two-dimensional panel. In some implementations (such as three-dimensional object 466), the three-dimensional object can be generated by center-depth wise alignment, in which the object is extended in both (front and back) directions, effectively placing the original two-dimensional panel in the middle of the new three-dimensional object.

In some implementations, a function can generate three-dimensional objects based on two-dimensional objects by initially creating the three-dimensional object as a flat object corresponding to the two-dimensional object, and then bending or curving the newly-created three-dimensional object. In some implementations, the bending or curving is controlled by the parameters passed to the function. In some implementations, the bending or curving is controlled by application calling the function.

FIG. 5 shows a two-dimensional parent panel 502 and two-dimensional child panels 504, 506, 508, 510. The two-dimensional parent panel 502 can be created by an application executing on a computing device based on parameters for a parent panel. The two-dimensional child panels 504, 506, 508, 510 can be created by the application executing on the computing device based on the parameters for the parent panel 502.

The application can create the child panels 504, 506, 508, 510 within a hierarchical structure where the existence, content, and/or layout of the child panels 504, 506, 508, 510 are defined by the parent panel 502. The application can first create the parent panel 502 based on a set of initial parameters. Subsequently, the application creates one or more child panels 504, 506, 508, 510 based on the parameters associated with that parent panel. This establishes a direct relationship in which the child objects (e.g. child panels 504, 506, 508, 510) are fundamentally linked to their parent (e.g. parent panel 502).

The application structure can be a nested hierarchy where parent composables (e.g. parent panel 502) define the content of their children (e.g. child panels 504, 506, 508, 510). This hierarchy can determine the size, location, and/or overall layout of the elements. The arrangement and placement of child panels with respect to the parent can be controlled by specific mechanisms, such as spatial alignment, which functions as the three-dimensional equivalent of two-dimensional alignment rules.

When transitioning from a two-dimensional view or two-dimensional environment to a three-dimensional view or three-dimensional environment, the three-dimensional parent and child panels can be generated based on their two-dimensional counterparts. Transformations such as bending, curving, or rotation that are applied to the parent panel are also applied to the child panels. This ensures that the entire group of panels moves and transforms together as a single, cohesive unit, maintaining their relative layout in three-dimensional space.

FIGS. 6A through 6F show a three-dimensional parent panel 602 and three-dimensional child panels 604, 606, 608, 610 generated based on the two-dimensional parent panel 502 and two-dimensional child panels 504, 506, 508, 510 of FIG. 5. The function that generates the three-dimensional object can receive, as a parameter, a definition or description of the two-dimensional parent panel 502 and/or child panels 504, 506, 508, 510. In the example shown in FIGS. 6A through 6C, the function bends and/or curves the two-dimensional parent panel 502 and/or child panels 504, 506, 508, 510 to generate the three-dimensional parent panel 602 and three-dimensional child panels 604, 606, 608, 610. In some implementations, the degree of bending or curving is based on a parameter received by the function. In some implementations, the bending or curving is based on a value included in the computer-executable code for the application.

In the example of FIGS. 6D through 6E, the function rotates the two-dimensional parent panel 502 and/or child panels 504, 506, 508, 510 in three-dimensional space before bending and/or curving the two-dimensional parent panel 502 and/or child panels 504, 506, 508, 510 to generate the three-dimensional parent panel 602 and three-dimensional child panels 604, 606, 608, 610. In some implementations, the degree of rotation, as well as the degree of bending or curving, is based on a parameter(s) received by the function. In some implementations, the degree of rotation, as well as the degree of bending or curving, is based on a value included in the computer-executable code for the application.

An alternative method involves manipulating a flat panel in three-dimensional space before bending the panels to create a more complex shape. The application can first generate a flat three-dimensional object that corresponds to the initial two-dimensional panel. The application can then bend, curve, and/or rotate the flat object in three-dimensional space. As shown in the example of FIGS. 5 and 6A through 6F, a flat two-dimensional parent panel 502 with multiple child panels 504, 506, 508, 510 can be transformed into a curved three-dimensional parent panel 602 with child panels 604, 606, 608, 610 arranged along a new curved surface. The degree of bending, curving, and rotation can be controlled by parameters passed to the generating function.

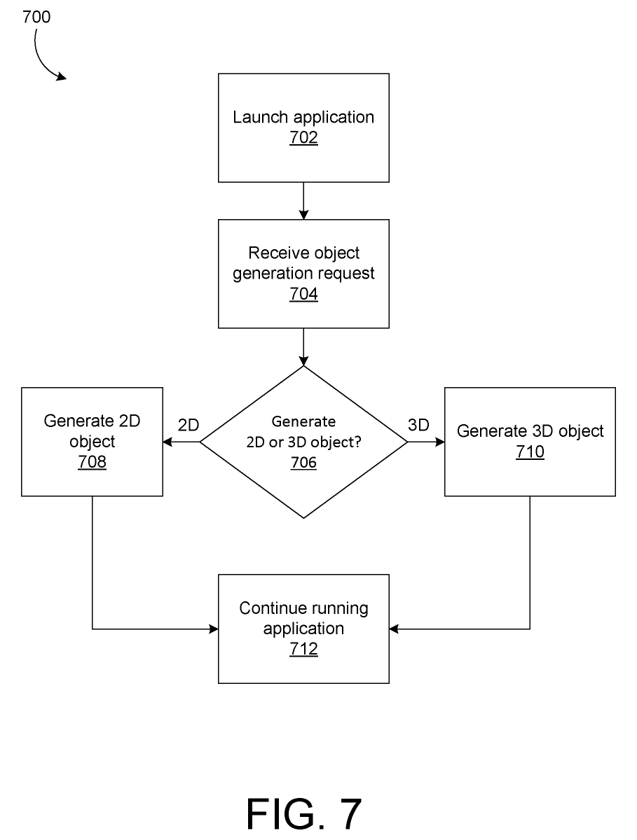

FIG. 7 shows a flowchart 700 for generating a two-dimensional object or three-dimensional object. The functions shown in the flowchart 700 can be performed by a computing device such as the first computing device 104A, 104B or second computing device 154A, 154B, by a computing system in communication with the first computing device 104A, 104B and/or second computing device 154A, 154B, or by a combination of the first computing device 104A, 104B, second computing device 154A, 154B, and/or computing system in communication with the first computing device 104A, 104B and/or second computing device 154A, 154B.

The flowchart 700 includes launching an application (702). The launching of the application (702) can include launching an application such as a gaming application or simulator application in a three-dimensional environment or a two-dimensional environment.

The flowchart 700 includes receiving an object generation request (704). The object generation request can be performed by a function or API such as the function 204. The object generation request can include parameters describing or defining the object to be generated. In some implementations, the parameters do not indicate whether the object is two-dimensional or three-dimensional. In some implementations, the parameters describe either a two-dimensional object or a three-dimensional object.

The flowchart 700 includes determining whether to generate a two-dimensional object or a three-dimensional object (706). The determination of whether to generate a two-dimensional object or a three-dimensional object (706) can be based on whether the environment in which the application is executing is a two-dimensional environment or a three-dimensional environment. If the application is executing in a two-dimensional environment, then the object will be generated as a two-dimensional object. If the application is executing in a three-dimensional environment, then the object will be generated as a three-dimensional object.

If the determination is made to generate a two-dimensional object, then the flowchart 700 includes generating a two-dimensional object (708). The two-dimensional object will be generated based on the parameters received by the function. In some implementations, the parameters describe or define how to create the two-dimensional object, and the two-dimensional object is generated based on the parameters. In some implementations, the parameters describe or define the object without respect to dimensionality, and the two-dimensional object is generated based on the parameters and the determination to generate the object as a two-dimensional object. In some implementations, the parameters describe or define how to create the object as a three-dimensional object, and a three-dimensional object is generated. A two-dimensional object is then generated based on the three-dimensional object, as described above with respect to FIGS. 3A and 3B.

If the determination is made to generate a three-dimensional object, then the flowchart 700 includes generating a three-dimensional object (710). The three-dimensional object will be generated based on the parameters received by the function. In some implementations, the parameters describe or define how to create the three-dimensional object, and the three-dimensional object is generated based on the parameters. In some implementations, the parameters describe or define the object without respect to dimensionality, and the two-dimensional object or three-dimensional object is generated based on the parameters and the determination to generate the object as a three-dimensional object. In some implementations, the parameters describe or define how to create the object as a two-dimensional object, and a two-dimensional object is generated. A three-dimensional object is then generated based on the two-dimensional object, as described above with respect to FIGS. 4A, 4B, and 6A through 6F. After generating the two-dimensional object (708) or generating the three-dimensional object (710), the flowchart 700 includes continuing running the application (712). The application can run with the generated two-dimensional object or three-dimensional object in the environment of the application.

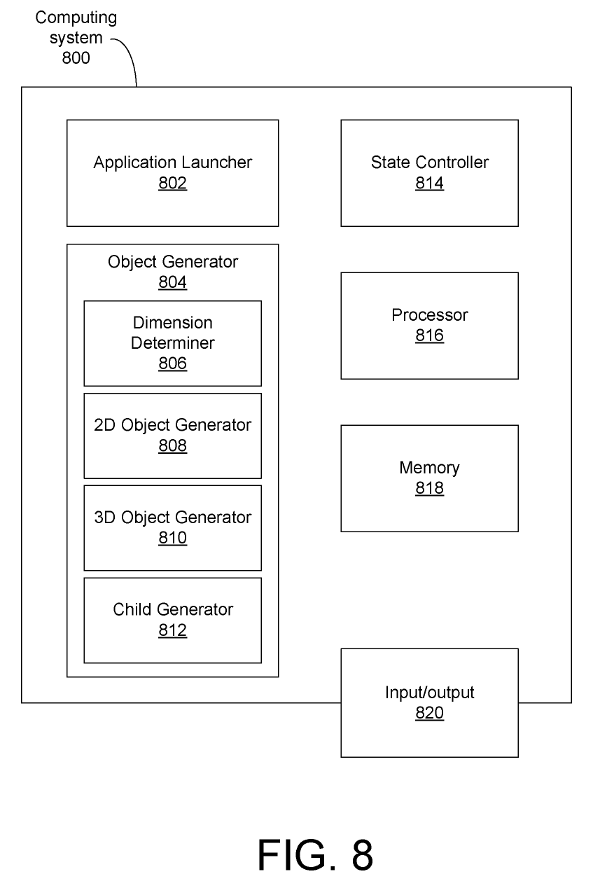

FIG. 8 is a block diagram of a computing system 800. The computing system 800 can be an example of, and/or implement features of, the first computing device 104A, 104B, the second computing device 154A, 154B, a computing device in communication with either of both of the first computing device 104A, 104B and/or second computing device 154A, 154B (such as a remote server), or any combination of the first computing device 104A, 104B, the second computing device 154A, 154B, and/or the computing device in communication with either or both of the first computing device 104A, 104B and/or second computing device 154A, 154B.

The computing system 800 can include an application launcher 802. The application launcher 802 can launch applications within which objects will be generated. The application launcher 802 can launch an application in response to a trigger, such as user request or other conditions such as the computing system 800 powering on or detecting an external event. The application launched by the application launcher 802 can be an application in which users interact with other users via a shared environment, such as a gaming application.

The computing system 800 can include an object generator 804. The object generator 804 can generate an object within the environment of the application launched by the application launcher 802. The object generated by the object generator 804 can be two-dimensional or three-dimensional, corresponding to the environment of the application. The object generator 804 can generate the object in response to a function called by the application.

The object generator 804 can include a dimension determiner 806. The dimension determiner 806 can determine a nature of a runtime environment of the application. The dimension determiner 806 detects whether the environment of the application is two-dimensional (e.g., a flat smartphone or tablet display) or three-dimensional (e.g., a virtual reality or extended reality headset). In some implementations, the dimension determiner 806 determines the dimensionality (i.e. two-dimensional or three-dimensional) based on capabilities of the hardware and/or operating system on which the application is running. In some implementations, the dimension determiner 806 determines the dimensionality based on a system-level function call querying the dimensionality of the environment.

Once the dimensionality is determined, the object generator 804 generates an object with the determined dimensionality. The object is generated based on the parameters (e.g. shape, color, and/or size) provided in the request to generate the object.

The object generator 804 can include a two-dimensional object generator 808. The two-dimensional object generator 808 can generate a two-dimensional object if the dimension determiner 806 determines that the environment is two-dimensional. If the parameters define a two-dimensional object, then the two-dimensional object generator 808 can generate the two-dimensional object based on the parameters. If the parameters define a three-dimensional object, then the two-dimensional object generator 808 can generate the two-dimensional object by generating the three-dimensional object, defining a plane that intersects the three-dimensional object, extracting features of the three-dimensional object that lie along the intersecting plan, and generating the two-dimensional object using the extracted features.

The object generator 804 can include a three-dimensional object generator 810. The three-dimensional object generator 810 can generate a three-dimensional object if the dimension determiner 806 determines that the environment is three-dimensional. If the parameters define a three-dimensional object, then the three-dimensional object generator 810 can generate the three-dimensional object based on the parameters. If the parameters define a two-dimensional object, then the three-dimensional object generator 810 can define a two-dimensional object based on the parameters, generate a subspace, extend the two-dimensional object along a third axis that is orthogonal (i.e. perpendicular) to the plane of the two-dimensional object, extruding the two-dimensional shape of the two-dimensional object into a three-dimensional volume. The parameters and/or application can control whether the extension is forward, backward, or in both directions from the original plane of the two-dimensional object.

The object generator 804 can include a child generator 812. The child generator 812 can generate child objects based on a parent object within a hierarchical structure that links properties of the parent and children. The child generator 812 can generate the child objects within a layout that is relative to the parent object. The positions, sizes, and other spatial properties of the child objects can be determined by the relationships of the child objects to the parent object. Child objects can include constraints based on the parameters used to generate the parent object, such as minimum and/or maximum distances of the child objects from the parent object. Spatial transformations, such as bending, curving, and/or rotating, that are applied to the parent object can be automatically applied to the child objects, maintaining the parent object and child objects as a single, cohesive unit.

The computing system 800 can include a state controller 814. The state controller 814 can maintain and share states of objects between devices (such as the first computing device 104A, 104B and second computing device 154A, 154B) by separating a visual representation of an object from underlying data of the object. The underlying data of the object can be considered the state of the object. This abstract state is synchronized across devices through a continuous, bidirectional communication loop, ensuring that users on different platforms (e.g., a two-dimensional smartphone and a three-dimensional VR headset) can interact with what they perceive as the same object.

The state controller 814 can maintain a distinction between an appearance of an object (the two-dimensional or three-dimensional visual representation) and an abstract state of the object. This state can be a shared set of data that defines properties of the object, such as shape, size, position, rotation, and/or color. Both devices maintain a local copy of this state. When a user interacts with an object, such as by dragging a two-dimensional object on a phone or pushing a three-dimensional object in a VR environment, the input of the user does not directly manipulate the visual rendering. Instead, the application executing on the device captures the input and translates the input into a modification of the shared object state (e.g., updating its positional coordinates). The device that received the input sends an indication of the change of state to the other device, such as over a network. This communication can be in the form of an action message that describes the modification. The receiving device receives this message and updates locally stored state information for the object. Based on this updated state, the application on the receiving device re-renders the local presentation of the object to reflect the change. This re-rendering ensures the movement or modification is accurately represented in the other environment, regardless of local dimensionality. This continuous loop of capturing input, modifying a shared state, communicating the change, and re-rendering the visual representation keeps the state of the object synchronized between all connected devices. This creates a seamless, interactive shared experience where actions in one environment are accurately and immediately reflected in the other. This conditional logic allows a developer to use a single line of code to generate an object, trusting the function to create the appropriate representation for the platform on which the application is running. This significantly reduces development time and the potential for errors by eliminating the need to write and maintain separate codebases for two-dimensional and three-dimensional applications.

The computing system 800 can include at least one processor 816. The at least one processor 816 can execute instructions, such as instructions stored in at least one memory device 818, to cause the computing system 800 to perform any combination of methods, functions, and/or techniques described herein.

The computing system 800 can include at least one memory device 818. The at least one memory device 818 can include a non-transitory computer-readable storage medium. The at least one memory device 818 can store data and instructions thereon that, when executed by at least one processor, such as the processor 816, are configured to cause the computing system 800 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 800 can be configured to perform, alone, or in combination with the computing system 800, any combination of methods, functions, and/or techniques described herein. The at least one memory device 818 can include a gesture library. The gesture library can include predetermined gestures. The predetermined gestures can include hand formations and/or movements and associated actions.

The computing system 800 may include at least one input/output node 820. The at least one input/output node 820 may receive and/or send data, such as from and/or to, a server, and/or may receive input and provide output from and to a user. The input and output functions may be combined into a single node, or may be divided into separate input and output nodes. The input/output node 820 can include a microphone, a camera (such as a front-facing camera), an IMU, a display, a speaker, a microphone, one or more buttons, and/or one or more wired or wireless interfaces for communicating with other computing devices.

FIGS. 9A, 9B, and 9C show an implementation of a head-worn device 900. The head-worn device can be an example of the first computing device 104A, 104B. As shown in FIGS. 9A, 9B, and 9C, the head-worn device 900 includes a frame 902. The frame 902 includes a front frame portion defined by rim portions 903A, 903B surrounding respective optical portions in the form of lenses 907A, 907B, with a bridge portion 909 connecting the rim portions 903A, 903B. Arm portions 905A, 905B are coupled pivotably or rotatably coupled, to the front frame by hinge portions 912A, 912B at the respective rim portion 903A, 903B. In some implementations, the lenses 907A, 907B may be corrective/prescription lenses. In some implementations, the lenses 907A, 907B may be an optical material including glass and/or plastic portions that do not necessarily incorporate corrective/prescription parameters. Displays 910A, 910B may be coupled in a portion of the frame 902. In the implementation shown in FIG. 9B, the displays 910A, 910B are coupled in the arm portions 905A, 905B and/or rim portions 903A, 903B of the frame 902. In some implementations, the head-worn device 900 can also include an audio output device 916 (such as one or more speakers), an illumination device 918, at least one processor 911, an outward-facing image sensor 914 (or camera), and gaze-tracking cameras 919A, 919B that can capture images of eyes of the user 102A, 102B to track a gaze of the user 102A, 102B. In some implementations, the head-worn device 900 may include a see-through near-eye display. The displays 910A, 910B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world through the lenses 907A, 907B, next to content (such as digital images, user interface elements, virtual content, and the like) generated by the displays 910A, 910B. In some implementations, waveguide optics may be used to depict content on the displays 910A, 910B via outcoupled light 920A, 920B. The images projected by the displays 910A, 910B onto the lenses 907A, 907B may be translucent, allowing the user 102A, 102B to see the images projected by the displays 910A, 910B as well as physical objects beyond the head-worn device 900.

FIG. 9D shows another implementation of the head-worn device 900. In this implementation, the head-worn device 900 is in goggle form, with a display included in the head-worn device 900 and a housing supporting the display enclosing the face and/or eyes of the user 102A, 102B. This implementation of the head-worn device 900 can support a virtual reality (VR) experience in which the user 102A, 102B sees only what is presented by the display included in the head-worn device 900.

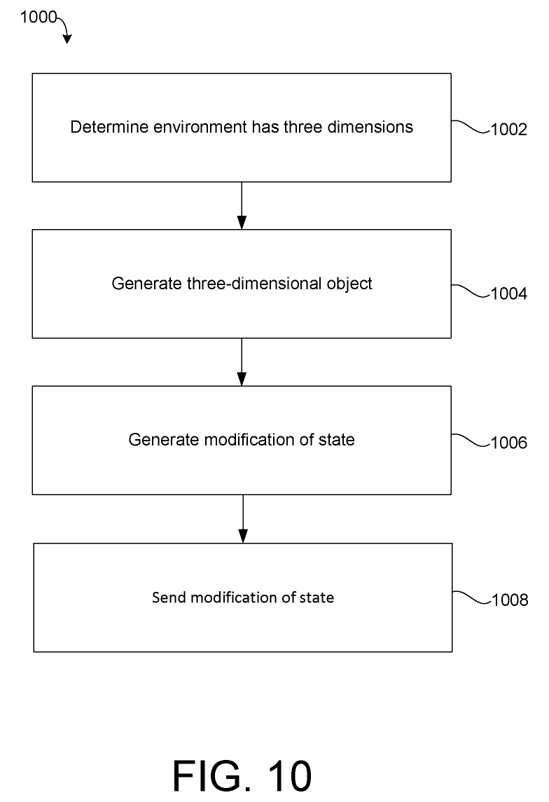

FIG. 10 is a flowchart of a method 1000. The method 1000 can be performed by any combination of one or more of the first computing device 104A, 104B, second computing device 154A, 154B, computing system 800, head-worn device 900, and/or any computing device in communication with one or more of the first computing device 104A, 104B, second computing device 154A, 154B, computing system 800, and/or head-worn device 900.

The method 900 can include determining that an environment has three dimensions (1002). Determining that the environment has three dimensions (1002) can include determining, at a first computing device and in response to a request to generate an object, that the environment in which an application is executing has three dimensions. The method 900 can include generating a three-dimensional object (1004). Generating the three dimensional object (1004) can include generating the three-dimensional object based on at least one parameter included in the request and based on determining that the environment has three dimensions. The method 900 can include generating a modification of a state (1006). Generating the modification of the state (1006) can include, in response to receiving input associated with the object, generating the modification of the state of the three-dimensional object. The method 900 can include sending the modification of the state (1008). Sending the modification of the state (1008) can include sending the modification of the state of the three-dimensional object to a second computing device, the second computing device executing the application in an environment having two dimensions.

In some implementations, sending the modification of the state of the three-dimensional object to the second computing device causes the second computing device to modify an appearance of a two-dimensional object displayed by the second computing device.

In some implementations, the method further includes receiving an action message from the second application, changing the state based on the action message, and changing an appearance of the three-dimensional object based on the change of the state.

In some implementations, the object is a parent object, and the method further comprises generating at least one child object based on the at least parameter included in the request, the at least one child object including a constraint based on the at least one parameter.

In some implementations, the constraint defines a spatial position of the at least one child object relative to the parent object, and the at least one child object is positioned in the three-dimensional environment based on the spatial position.

In some implementations, the request comprises an application programming interface (API) call to a function, and the function determines that the environment has three dimensions.

In some implementations, the at least one parameter defines a two-dimensional shape, and generating the three-dimensional object comprises extending the two-dimensional shape along an axis perpendicular to a plane of the two-dimensional shape.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the implementations of the disclosure.

What is claimed is:

1. A method, comprising:
determining, at a first computing device and in response to a request to generate an object, that an environment in which an application is executing has three dimensions;
generating a three-dimensional object based on at least one parameter included in the request and based on determining that the environment has three dimensions;
in response to receiving input associated with the object, generating a modification of a state of the three-dimensional object; and
sending the modification of the state of the three-dimensional object to a second computing device, the second computing device executing the application in an environment having two dimensions.

2. The method of claim 1, wherein sending the modification of the state of the three-dimensional object to the second computing device causes the second computing device to modify an appearance of a two-dimensional object displayed by the second computing device.

3. The method of claim 1, further comprising:
receiving an action message from the second application;
changing the state based on the action message; and
changing an appearance of the three-dimensional object based on the change of the state.

4. The method of claim 1, wherein:
the object is a parent object, and
the method further comprises generating at least one child object based on the at least parameter included in the request, the at least one child object including a constraint based on the at least one parameter.

5. The method of claim 4, wherein the constraint defines a spatial position of the at least one child object relative to the parent object, and wherein the at least one child object is positioned in the three-dimensional environment based on the spatial position.

6. The method of claim 1, wherein the request comprises an application programming interface (API) call to a function, and wherein the function determines that the environment has three dimensions.

7. The method of claim 1, wherein the at least one parameter defines a two-dimensional shape, and wherein generating the three-dimensional object comprises extending the two-dimensional shape along an axis perpendicular to a plane of the two-dimensional shape.

8. A non-transitory computer-readable storage medium comprising instructions stored thereon that, when executed by at least one processor, are configured to cause a first computing device to:
determine, in response to a request to generate an object, that an environment in which an application is executing has three dimensions;
generate a three-dimensional object based on at least one parameter included in the request and based on determining that the environment has three dimensions;
in response to receiving input associated with the object, generating a modification of a state of the three-dimensional object; and
sending the modification of the state of the three-dimensional object to a second computing device, the second computing device executing the application in an environment having two dimensions.

9. The non-transitory computer-readable storage medium of claim 8, wherein sending the modification of the state of the three-dimensional object to the second computing device causes the second computing device to modify an appearance of a two-dimensional object displayed by the second computing device.

10. The non-transitory computer-readable storage medium of claim 8, wherein the instructions are further configured to cause the first computing device to:
receive an action message from the second application;
change the state based on the action message; and
change an appearance of the three-dimensional object based on the change of the state.

11. The non-transitory computer-readable storage medium of claim 8, wherein:
the object is a parent object, and
the instructions are further configured to cause the first computing device to generate at least one child object based on the at least parameter included in the request, the at least one child object including a constraint based on the at least one parameter.

12. The non-transitory computer-readable storage medium of claim 11, wherein the constraint defines a spatial position of the at least one child object relative to the parent object, and wherein the at least one child object is positioned in the three-dimensional environment based on the spatial position.

13. The non-transitory computer-readable storage medium of claim 8, wherein the request comprises an application programming interface (API) call to a function, and wherein the function determines that the environment has three dimensions.

14. The non-transitory computer-readable storage medium of claim 8, wherein the at least one parameter defines a two-dimensional shape, and wherein generating the three-dimensional object comprises extending the two-dimensional shape along an axis perpendicular to a plane of the two-dimensional shape.

15. A first computing device comprising:
at least one processor; and
a non-transitory computer-readable storage medium comprising instructions stored thereon that, when executed by at the least one processor, are configured to cause the first computing device to:
determine that an environment in which an application is executing has three dimensions in response to receiving a request to generate an object;
generate a three-dimensional object based on at least one parameter included in the request and based on determining that the environment has three dimensions;
in response to receiving input associated with the object, generating a modification of a state of the three-dimensional object; and
sending the modification of the state of the three-dimensional object to a second computing device, the second computing device executing the application in an environment having two dimensions.

16. The first computing device of claim 15, wherein sending the modification of the state of the three-dimensional object to the second computing device causes the second computing device to modify an appearance of a two-dimensional object displayed by the second computing device.

17. The first computing device of claim 15, wherein the instructions are further configured to cause the first computing device to:
receive an action message from the second application;
change the state based on the action message; and
change an appearance of the three-dimensional object based on the change of the state.

18. The first computing device of claim 15, wherein:
the object is a parent object, and
the instructions are further configured to cause the first computing device to generate at least one child object based on the at least parameter included in the request, the at least one child object including a constraint based on the at least one parameter.

19. The first computing device of claim 18, wherein the constraint defines a spatial position of the at least one child object relative to the parent object, and wherein the at least one child object is positioned in the three-dimensional environment based on the spatial position.

20. The first computing device of claim 15, wherein the at least one parameter defines a two-dimensional shape, and wherein generating the three-dimensional object comprises extending the two-dimensional shape along an axis perpendicular to a plane of the two-dimensional shape.
